(19) United States
(12) Patent Application Publication
(10) Pub. No.: US 2003/0189002 A1
(43) Pub. Date: Oct. 9, 2003

(54) Composite water filter

(76) Inventors: Andrew Proulx, Concord, MA (US); Kitty K. Siu, Westford, MA (US); Gary Alan O'Neill, Tyngsborough, MA (US)

Correspondence Address: MILLIPORE CORPORATION, 290 CONCORD ROAD, BILLERICA, MA, 01821, US

(21) Appl. No.: 10/406,548

(22) Filed: Apr. 3, 2003

Related U.S. Application Data
(60) Provisional application No. 60/369,936, filed on Apr. 4, 2002.

(51) Int. Cl. B01D 24/00

(52) U.S. Cl. 210/284

(57) ABSTRACT

The present invention is a composite filter for use with recycling gray water. The filter is comprised of a housing containing a series of filters, a first depth filter, preferably made of cellulose fibers for removing particles and turbidity causing materials, a second depth filter, preferably made of cellulose and diatomaceous earth for removing additional particles and turbidity causing materials, an organics filter, preferably a carbon filter to remove organic material and an ion exchange material to remove dissolved ionic species such as salts, acids and the like.

The present invention relates to a composite water filter for removing organics, salts, acids and inorganic species from gray water. More particularly, it relates to a composite water filter for removing organics, salts, acids and inorganic species from gray water that is useful in recirculating showers, sink water and other applications reusing gray water.

### BACKGROUND OF THE INVENTION

In many places and applications, water is plentiful and is used only once before being disposed of. However, there are places and applications such as where water is scarce or doesn't normally exist and therefore must be carried in, that the conservation of water is critical.

For that reason, luxuries, such as showers and wash sinks on airplanes, yachts, campers, even space stations are uncommon as the supply of water that can be carried is limited due to its weight and space requirements. In other applications, the amount of water available, such as in arid or desert areas of the world or areas in drought, also limit the ability of one to use water for non-essential purposes.

Attempts have been made to recover and reuse the dirty or “gray” water in order to extend the use of the water. These attempts have either required large systems such as recovery ponds, centrifuges, distillers and the like or in smaller systems, the approach has been to rely on filters, which has been less than successful. For example, one system for showers consists of a series of filters comprised of a polypropylene screen filter followed by one or more activated carbon filters to clarify the water for reuse. See U.S. Pat. No. 4,828,709. U.S. Pat. No. 5,293,654 uses a screen filter followed by a carbon filter to filter dirty water that had been collected in a reservoir for reuse. U.S. Pat. No. 4,432,103 eliminates the use of filters altogether and relies on steam instead of water for the shower system.

Such systems have been capable of providing a limited number of showers or reuses, typically five or less uses of the water before the filters were exhausted and needed to be replaced. The cost of the filters averaged per shower has made this approach unacceptable. Additionally, replacing the cartridges is time consuming and the cartridges themselves take up a large volume of space that is a premium in many applications. Those systems that eliminate the use of filters rely on high energy consumption devices such as steam generators which are not an attractive economical alternative.

What is desired is a filter system for gray water that provides acceptable water quality for non-potable uses, such as showers and hand washing, that is economical and compact. The present invention provides such a system.

### SUMMARY OF THE INVENTION

The present invention is a composite filter for use with recycling gray water. The filter is comprised of a housing containing a series of filters, a first depth filter, preferably made of cellulose fibers for removing particles and turbidity causing materials, a second depth filter, preferably made of cellulose and diatomaceous earth for removing additional particles and turbidity causing materials, an organics filter, preferably a carbon filter to remove organic material and an ion exchange material to remove dissolved ionic species such as salts, acids and the like. The filter is replacable and is preferably housed within a permanent vessel that is connected to the water reuse system.

It is an object of the present invention to provide a composite filter comprising a housing having a first end and a second end, each end being sealed in a liquid-tight manner by a first and a second endcap respectively, the first endcap having an inlet for fluid from a from a gray water source, the second endcap having an outlet from the housing, a first filter stage arranged in the housing adjacent and downstream of the inlet and a second stage arranged downstream of the first stage and adjacent the outlet, the first stage comprising a two or more depth filters in series followed by an organics filter, the first stage being arranged in a liquid-tight manner such that gray water entering the inlet must flow through the first stage before reaching the second stage and the second stage comprising an ion exchange media for the removal of dissolved ionic species from the gray water.

### IN THE DRAWINGS

FIG. 1 shows a first embodiment of a filter according to the present invention in cross section.

FIG. 2 shows a second embodiment of a filter according to the present invention in cross section.

FIG. 3A shows a first embodiment of the bottom of first stage of the filter according to FIG. 1 in planar view.

FIG. 3B shows a second embodiment of the bottom of first stage of the filter according to FIG. 1 in planar view.

FIG. 4 shows one typical water recirculation system in which the present invention is useful.

FIG. 5 shows an alternative inlet valve useful in the present invention.

FIG. 6A shows the conductivity readings of a prior art system described in Example 1.

FIG. 6B shows the turbidity readings of a prior art system described in Example 1.

FIG. 7A shows the conductivity readings of the system of the present invention described in Example 1.

FIG. 7B shows the turbidity readings of the system of the present invention described in Example 1.

FIG. 8A shows the conductivity readings of the system of the present invention described in Example 2.

FIG. 8B shows the turbidity readings of the system of the present invention described in Example 2.

FIG. 9A shows the conductivity readings of the system of the present invention described in Example 3.

FIG. 9B shows the turbidity readings of the system of the present invention described in Example 3.

### DETAILED DESCRIPTION OF THE INVENTION

A filter of the present invention is comprised of a housing containing a series of elements, a first depth filter, preferably made of cellulose fibers for removing particles and turbidity causing materials, a second depth filter, preferably made of cellulose and diatomaceous earth for removing additional particles and turbidity causing materials, an organics filter, preferably a carbon filter to remove organic material and an ion exchange material to remove dissolved ionic species such as salts, acids and the like. The ends of the housing are sealed by endcaps that form a liquid-tight seal with the filter housing. The filter housing is preferably then retained within a pressure vessel that has two end plates, one containing an inlet, the other containing an outlet.

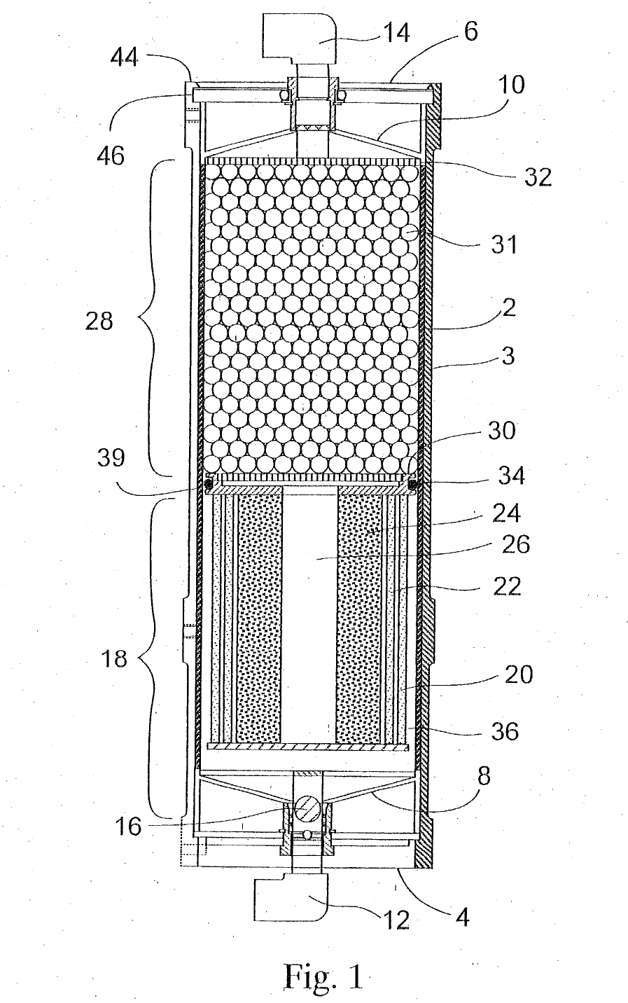

FIG. 1 shows a first embodiment of the present invention. The filter is formed of a housing 2, having a first end 4 and a second end 6 that is distal from the first end 4. As shown in this preferred embodiment, the filter housing is retained within a pressure vessel 3. The pressure vessel 3 is preferably made of a high strength material as described below and is a permanent feature of the recycling system. Filter cartridges of the present invention are placed into the vessel and used until exhausted and then changed out. The first end 4 of the filter housing 2 is sealed by a first endcap 8 and the second end 6 is sealed by a second endcap 10. The first endcap 8 contains an inlet 12 from a gray water source (not shown) such as a shower drain, handwashing sink or a washing machine drain. The second endcap 10 contains an outlet 14 from the housing 2. The vessel 3 has an inlet plate 5 in line with the inlet 12 of the endcap 8. It contains the connection to the gray water supply, which in this Figure is represented by the elbow 13. Likewise, the vessel 3 has an outlet plate 7 in line with the outlet 14 of the endcap 10. It contains the connection to the gray water supply, which in this Figure is represented by the elbow 15.

While the inlet is shown in the various embodiments discussed in this application as being at the bottom of the filter, it could be at the top and the outlet likewise could be arranged to be at the bottom rather than at the top of the system as shown in the Figures. It is preferred that the inlet be at the bottom. However, if the inlet were at the top, one would simply need to arrange for the venting of gas, such as through a vent such as hydrophobic membrane containing vent such as a MILLEX™ vent available from Millipore Corporation of Bedford, Mass.

In another embodiment, the filter could be arranged such that the inlet and outlet are on the same end of the device. Fluid would flow into the filter housing through the inlet, then through the two stages of filtration and then exit the filter to a return tube or channel formed in either the filter housing of vessel to an outlet located adjacent to but separate from the inlet.

The embodiment of FIG. 1 shows a ball value 16 on the inlet 12 of the housing 2. This is preferred, although not necessary. It is used to prevent any backwash of water in the system as well as to prevent drippage of water in the housing 2 when it is changed out.

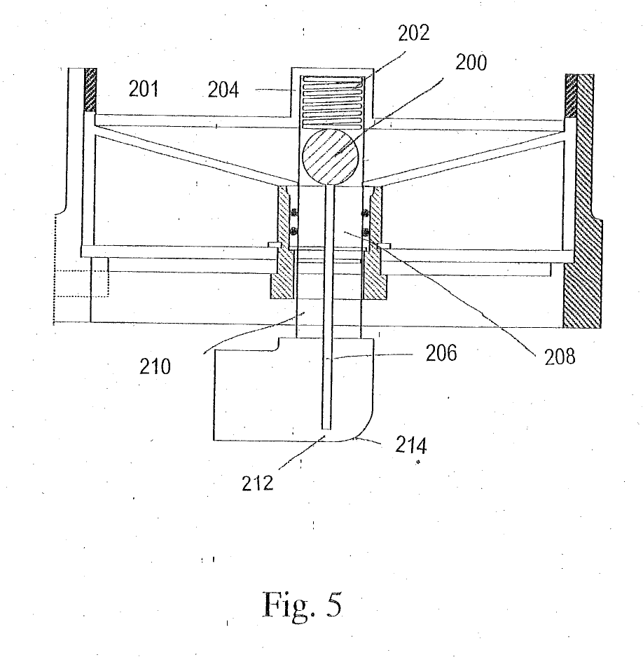

An alternative spring actuated ball valve for the system is shown at FIG. 5. In this embodiment, only the bottom portion of the filter device of the present invention is shown. A ball 200 is biased by a spring 202 that is retained within a cage 204 or other such structure within the filter housing 201. A movable pin 206 is located and attached within the filter housing's inlet 208. When the filter housing is placed within the vessel housing 210, the pin contacts a portion of the vessel housing 210 such as the inner surface 212 of the connector 214 and the pin 206 is moved toward the ball 200, overcoming the action of the spring 202, so that fluid can flow past the ball 200 and into the filter housing 201. As the filter is removed from the vessel housing 210, the pin retracts allowing the spring 202 to bias the ball 200 into a closed position so that no fluid flow occurs into or out of the filter housing 201.

Downstream from the filter inlet 12 is the first stage 18 of the device. This stage is comprised of a series of filters, in this embodiment three are shown, 20, 22, 24 that are designed for the removal of particles and colloidal materials such as dirt and debris and organics such as soaps and other surfactants that may be contained in the water.

Preferably, the filters are arranged so that the largest material such as dirt or debris are removed by at least the first filter 20, and preferably by the first two filters 20, 22. The organics are then removed by filter 24.

In this embodiment, the filters 20, 22, 24 are arranged in series and concentrically to each other such that liquid flows from the inlet 12 to the outside of the first stage 18 and then sequentially through filter layers 20, 22 and then 24. After passing through filter layer 24, the filtered fluid enters the first stage core 26. The fluid then exits the first stage 18 and enters the second stage 28 via a flow distributor 30.

The second stage 28 is comprised of ion exchange media used to remove dissolved ionic species, organic acids and inorganic materials. The media 31 as shown is in the form of ion exchange beads. However, other forms of ion exchange media 31 may be used such as woven or non-woven grafted ion exchange fabrics, monoliths and the like. The beads may be in the form of a mixed bed of anionic and cationic beads or they may be formed into a series of beds containing either cationic or anionic beads. Additional materials such as electrically conductive beads such as metals or carbon can also be added to the ion exchange media as desired.

The media 31 is retained within the housing 2 by the flow distributor 30 and a flow collector 32 at the down stream end of the second stage 28. Fluid passing through the flow collector 32 is passed into the outlet 14 of the housing 2 for further processing or use.

The use of the flow distributor 30 ensures that even, uniform flow occurs through the bed, thereby eliminating channeling or uneven use of the ion exchange media. If desired, other flow control features, such as baffles or additional flow distributors within the second stage 28 may also be used.

The first stage 18 as shown in FIG. 1 is a self contained unit forming a liquid-tight seal, thus isolating it from the second stage 28 by a gasket 34 at the outer periphery of the downstream end of the first stage which forms the liquid-tight seal between the inner diameter of the filter housing 2 and the outer diameter of the first stage 18. In this manner, all fluid entering the filter housing 2 through inlet 12 must pass through the filters 20, 22, 24 of the first stage 18 and the flow distributor 30 before reaching the second stage 28. Alternative methods for obtaining the liquid-tight seal such as adhesive bonding of the first stage in place may also be used if desired.

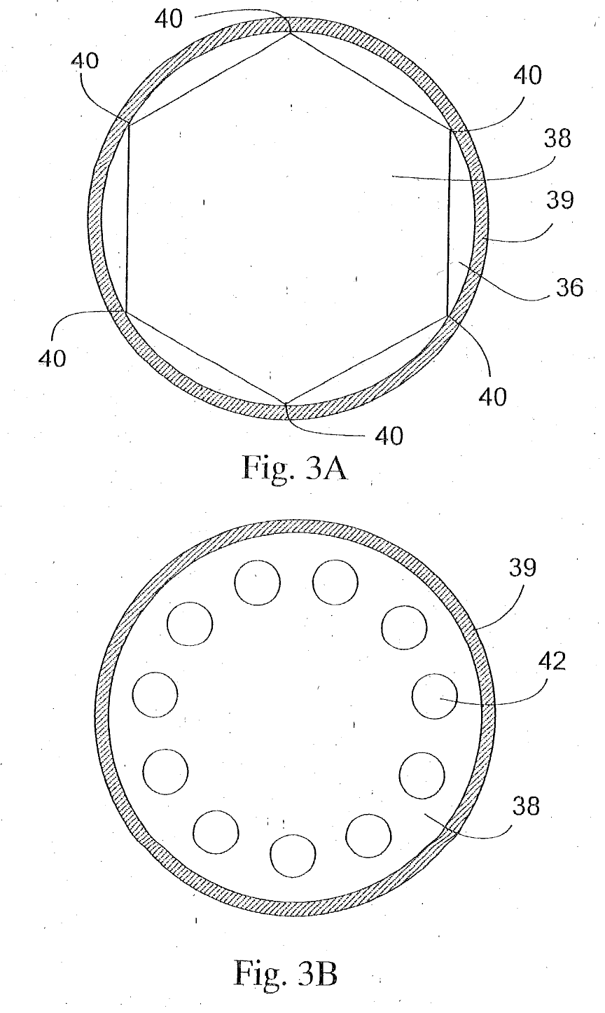

As shown in FIG. 1, there are one or more spaces 36 formed between the inlet 12, the inner diameter 39 of the housing 2 and the first filter 20. These spaces 36 are to allow fluid to reach the first stage 18. The upstream end 38 of the first stage 18 as it appears in FIG. 1 seems to be unsupported against the inner diameter 39 of the housing 2. Yet in fact the end 38 does contact the inner diameter 39 of the housing 2 at two or more, preferably three or more points. In the embodiment of FIG. 1, the end 38 is shaped in a hexagonal design and the points 40 of the hexagon end 38 touch and are supported against the inner diameter 39 of the filter housing 2. This is shown in FIG. 3A.

While a hexagonal shape is shown, other shapes such as triangles, quadrangles (squares, rectangles, rhomboids), pentagons, octagons, circles, ovoid and the like may also be used so long as there are sufficient spaces to allow for unhindered fluid flow into the first stage.

Alternatively, one can use an end 38 that is circular in shape and is substantially the same diameter as that of the inner diameter 39 of the housing 2 so that it is essentially supported around its entire periphery rather than at points as in FIG. 3A. FIG. 3B shows one such embodiment where the end has a series of holes 42 around the periphery of the end 38, inboard of the ends and outboard of the first filter 20. These holes 42 form the spaces 36 for fluid flow to occur. Another embodiment (not shown) forms a scalloped edge that allow for the fluid to freely flow into the first stage.

The device of FIG. 1 is assembled in the following manner. The first stage 18 is formed as an integral unit formed of the filters 20, 22, 24 attached to the end 38 and the flow distributor 30 so as to form a liquid-tight seal between the edges of the filter layers 20, 22, 24 and the end 38 and distributor 30 respectively. The seal may be accomplished by glues, such as hot melt glues, silicone and other elastomeric adhesives, thermal bonding and the like. Preferably, one uses a polyethylene hot melt glue to secure the edges of the filters 20, 22, 24 to the end 38 and distributor 30.

The housing 2 is formed with the end cap 8 being attached to the housing 2. This may occur by adhesives, thermal bonding, mating screw threads on the endcap and housing or if desired a compression fit.

The first stage 18 is then slid into the housing 2 from the other end of the housing 2. If desired, one could form standoff pegs (not shown) on the end 38 to ensure that the first stage 18 is located at a desired and consistent position in the housing 2.

The ion exchange media, in whatever form is desired, is then placed on top of the flow distributor 30 until a desired depth is achieved. Preferably, if media is in the form of beads and the depth to which the housing 2 is filled is slightly greater than the finished depth to ensure adequate packing of the media to ensure even and uniform flow through the second stage 28. Flow collector 32 is then placed upon the bed of media and the end cap 10 is sealed to the filter housing 2, slightly compressing the media of the second stage 28. This seal may be achieved by many methods such as thermal or vibration bonding or through the use of a seal such as an O-ring on the outer diameter of the endcap or the endcap may be held in place with a snap fit or snap ring.

The vessel 3 has plate 5 attached to a first end, such as by screws, rivets, glue, welds, snap fittings, mated threads on the inner diameter of the vessel 3 and the end plate 5 and the like. The filter is then inserted into the pressure vessel 3 and the second end plate 7 is removably attached to the vessel 3 by screws, snap fittings, corresponding mated threads on the inner diameter of the vessel 3 and the end plate 7 and the like to contain the filter housing 2 in place. The end plates are connected to the gray water source by elbow 13 and the water use or clean water reservoir (not shown) by elbow 15.

As shown in FIG. 1, the end cap 10 is retained in the housing 2 by a lock tab 44 and groove 46. Alternatively, mechanical devices such as C-ring arrangement, a set of corresponding male/female threads on the end cap 10 and inner diameter 39 of the housing 2 or set screws or rivets may be used or the end cap 10 can be adhered or thermally or vibrationaly bonded in place.

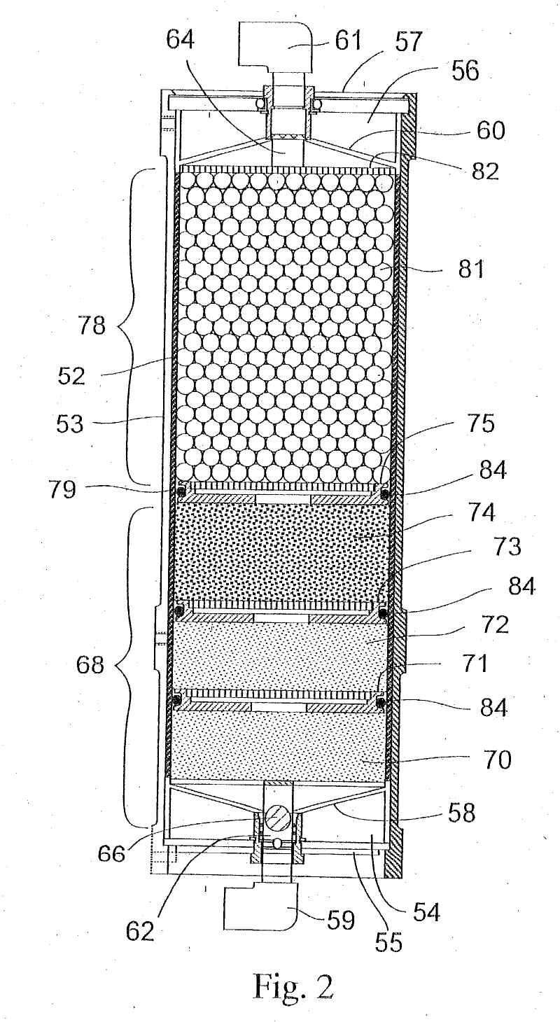

FIG. 2 shows a second embodiment of the present invention. The filter is formed of a housing 52, having a first end 54 and a second end 56 that is distal from the first end 54. The first end 54 is sealed by a first endcap 58 and the second end 56 is sealed by a second endcap 60. The housing 52 is contained within a vessel 53 that has a first end plate 55 and a second end plate 57. The end plates contain the plumbing connections 59 and 61 to the rest of the system. The first endcap 58 contains an inlet 62 from the first end plate 55 and the connection 59 that is connected to a gray water source (not shown) such as a shower drain or a washing machine drain. The second endcap 60 has an outlet 64 that is in fluid communication with the second connection 61 from the vessel 53 outlet 61 that returns cleaned water to the system.

The embodiment of FIG. 2 shows a ball value 66 in fluid communication with the inlet 62 of the filter housing 52. This is preferred, although not necessary. It is used to prevent any backwash of water in the system as well as to prevent drippage of water in the housing 52 when the filter cartridge is changed. Alternatively, one can use the valve design shown in FIG. 5 if desired.

Downstream from the inlet is the first stage 68 of the device. This stage is comprised of a series of filters, in this embodiment three are shown, 70,72, 74 that are designed for the removal of particles and colloidal materials such as dirt and debris and organics such as soaps and other surfactants that may be contained in the water.

Preferably, the filters are arranged so that the largest material such as dirt or debris are removed by at least the first filter 70, and preferably by the first two filters 70, 72. The organics are then removed by an organics removal filter 74.

In this embodiment, the filters 70, 72, 74 are arranged in series, but unlike the embodiment of FIG. 1 they are not arranged concentrically to each other. Rather they are arranged in a linear series with one feeding fluid sequentially to the next filter in line. Liquid flows from the inlet 62 to the outside of the first stage 68 and then sequentially through filter layers 70, 72 and then 74. Each layer is separated from the other by a distributor plate 71, 73, and 75 that allows for the flow of the filter fluid from filter 70 to pass through plate 71 and into filter 72. Fluid from filter 72 then passes through plate 73 and into filter 74. After passing through filter layer 74, the filtered fluid enters the plate 75 and then exits the first state 68 and enters the second stage 78 via the plate 75 that also acts as a flow distributor for the second stage 78.

The second stage 78 is comprised of ion exchange media used to remove dissolved ionic species and inorganic materials as described above in relation to the embodiment of FIG. 1. The media 81 as shown is in the form of ion exchange beads. However, other forms of ion exchange media 81 may be used such as woven or non-woven grafted ion exchange fabrics, monoliths and the like.

The media 81 is retained within the filter housing 52 by the plate 75 and a flow collector 82 at the downstream end of the second stage 78. Fluid passing through the flow collector 82 is passed into the outlet 64 of the housing 52 and then to the connector 61 for further processing or use.

The filter layers 70, 72, 74 of the first stage 68 are liquid-tightly sealed around their outer peripheral edges by gaskets 84 which form the liquid-tight seal between the inner diameter 89 of the housing 52 and the outer diameter of the plates 71, 73, 75. In this manner, all fluid entering the filter housing 52 through inlet 62 must pass sequentially through the filters 70, 72, 74 of the first stage 68 and the plates 71, 73, and 75 before reaching the second stage 78. Alternative methods for obtaining the liquid-tight seal, such as adhesive bonding, thermal or vibrational welding or the like, of the filter layers 70, 72, 74 of the first stage 68 in place may also be used if desired.

The filter layers 70, 72 and 74 are the same type as that used in the embodiment of FIG. 1 and additional layers may be used if desired so long as pressure drop and flow rates are not adversely compromised. The filter layers maybe monolithic or formed of a series of flat sheets stacked on top of each other or other arranged so that fluid must be filtered by the layer before it passes on to the next layer or the second stage of the system.

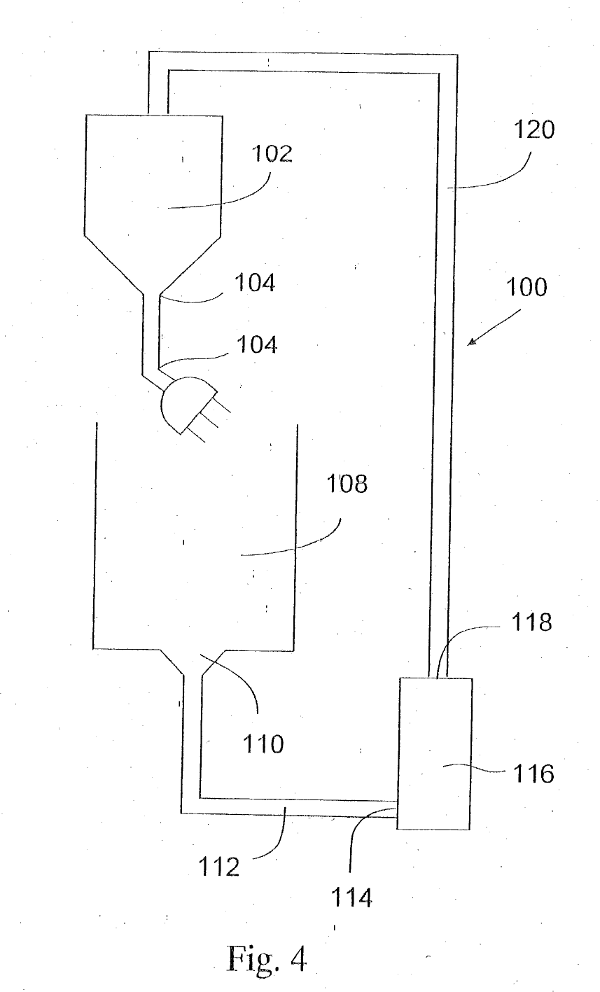

FIG. 4 shows a filter according to the present invention in a water recovery system. The system 100 comprises one or no reservoirs for water 102 in this example one is shown, although several may be used depending upon whether one is used for heated water and the other cold water or whether one has true capacity to have more than one parallel system. The outlet 104 for the reservoir is connected to the inlet 106 for the water use, in this example a shower 108. The outlet 110 for the water use system 108, in this example a drain, collects all of the used or gray water and supplies it via conduit 112 to the inlet 114 of the filter 116 of the present invention. Filtered water exits the outlet 118 of the filter 116 and is returned to the reservoir 102 by conduit 120.

The system may be pressurized such as by a pump or an air pressure system (not shown). The use of two or more reservoirs and other plumbing arrangements may also allow the system to be gravity fed. A pump or pressurized system is preferred as it supplies steady and constant pressure and flow to the system.

Additional features of the system may include various bio burden reducing means such as UV chambers or chlorinators silver nitrate beds, and the like through which the water must flow so as to kill any bacteria, molds, viruses and the like that may be in the gray water. Alternatively, filters such as bacterial grade filters may be used, however their flow is lower and pressure drop is higher than that of the rest of the system and is typically not acceptable in providing a fast and efficient recovery of water.

Other devices such as water heaters, new make up water supplies (if desired or necessary depending upon the system design), drains for the reservoir, conduits and the like or mixing valves and other valves for controlling the water flow through the system may also be used as desired as well as water quality monitors and instruments, such as pH meters, pressure gauges, conductivity meters, turbidity meters and the like that are used to determine the state of the water and the filter.

The embodiments of FIGS. 1 and 2 show the use of a pressure vessel surrounding the filter housing. This pressure vessel is not necessary in all applications. However in applications where fire resistance, burst strength, G-force resistance or esthetics are required or desired, one can use a pressure vessel to provide that effect. For example for aircraft, fire resistance, high G-force resistance and burst strength of all components are required. Rather than make the filter housing from an expensive material (as it is designed for a single use), one can use a permanent pressure vessel that has the required features and use an inexpensive material for the disposable filter housing. In such a use, the pressure vessel may be formed of metal such as aluminum, steel, stainless steel and the like, composite materials and engineered plastics. In other applications, one could eliminate the pressure vessel and use a thicker or stronger wall material for the filter housing, however this adds to the cost of the filter that is desired to be disposable.

In a preferred embodiment of this design, the depth filters comprise two or more layers of different materials. Two different grades of media, diatomaceous earth (DE), cellulose binder (CE) are considered the most useful depth medias for the present invention. Each such media has different pore size ranges, so a great variety of different filters can be made for the present invention. DE has at least 12 pore size ranges and CE has at least 8 pore size ranges. It is preferred that at least the second filter layer contain diatomaceous earth. These media is known as MILLISTAK+™ media available from Millipore Corporation of Bedford, Mass.

The carbon filter may be in the form of loose carbon beads, bound carbon beads in a matrix, carbon fabric or wound carbon fibers. A preferred carbon filter is a wound carbon fiber filter known as a C245 cartridge available from Fiberdyne Corporation.

The ion exchange material useful in the invention can be in the form of beads, fabrics or monoliths. Beads are preferred as they are the most commonly available, have good flow characteristics with low pressure drops and provide acceptable performance. Preferably, the beads are formed of mixed ion exchange resin, anionic and cationic resins. Such resins are available from a variety of suppliers such as Rohm & Haas of Philadelphia, Pa., and Dow Corporation of Midland, Mich.

The flow distributor(s) and flow collector are typically desired especially between at least the first and second stages so that the ion exchange material is effectively and uniformly used throughout its depth. Any relatively large pored material such as plastic or metal screens, sintered metal, plastic or glass frits, plastic non-wovens, glass fabrics, woven or non-woven, as well as membranes may be used. A preferred material is a POREX® membrane available from Porex Technologies Corporation of Fairburn Ga.

The filter housing 2 can be formed of metal such as aluminum or stainless steel, glass or plastic, however plastic is preferred due to its strength, low cost, ready availability in a number of configurations and dimensions and low susceptibility to corrosion by water and other constituents contained in the water. Suitable plastics include but are not limited to polyethylene, polypropylene, PVC, PVDF, ABS, EVA copolymers, PTFE resin, PFA and other thermoplastic perfluorinated resins, polystyrenes, polycarbonates, nylons and other polyamides as well as thermosets such as epoxies or urethanes. Composites such as fiberglass, carbon or graphite composite housings may also be used if desired.

The pressure vessel, if used, can be formed of metal, glass or plastic, with metal being preferred due to its strength. Suitable metals include but are not limited to such as aluminum, steel or stainless steel. Suitable plastics include but are not limited to polyethylene, polypropylene, PVC, PVDF, ABS, EVA copolymers, PTFE resin, PFA and other thermoplastic perfluorinated resins, polystyrenes, polycarbonates, nylons and other polyamides as well as thermosets such as epoxies or urethanes. Composites such as fiberglass, carbon or graphite composite housings may also be used if desired.

The shape and size of the housing is not critical. Preferably, it is in the form of a cylindrical tube although tubes of other shapes such as square, hexagonal, octagonal or other polygonal shapes may be used. Alternatively, to take advantage of irregular empty spaces, one could custom design a filter housing to fit within the existing space.

The length and width of the housing is dependent upon several parameters, the desired capacity, the space available and the design of the filters (whether concentric, serial, etc). The housing can be of any dimensions that meet the desired results. For example the housing may have a relatively short length and a relatively wide cross dimension where height is at a premium or it may have a relatively long height dimension and a relatively narrow cross dimension where width is at a premium. As a general standard in the water purification industry, a device containing ion exchange media typically uses a configuration with at least a 2:1 length to diameter aspect ratio in order to achieve optimum flow and even usage of the ion exchange media. However, there may be instances where this rule is sacrificed in order to fit the filter device to the available space.

In one preferred embodiment similar to that of FIG. 1, the first stage filter had a length of 5 inches (127 mm) and a width of 3.6 inches (91.44 mm).

### EXAMPLE 1

A system of the prior art consisting of three commercially available filter cartridges in series, each contained in their own housing and connected together by conduits was tested. The filters used were, in order, a POLYGARD® 5 microns depth filter, a SUPER C® carbon filter and an IONEX® ion exchange resin cartridge, all of which are available from Millipore Corporation of Bedford, Mass.

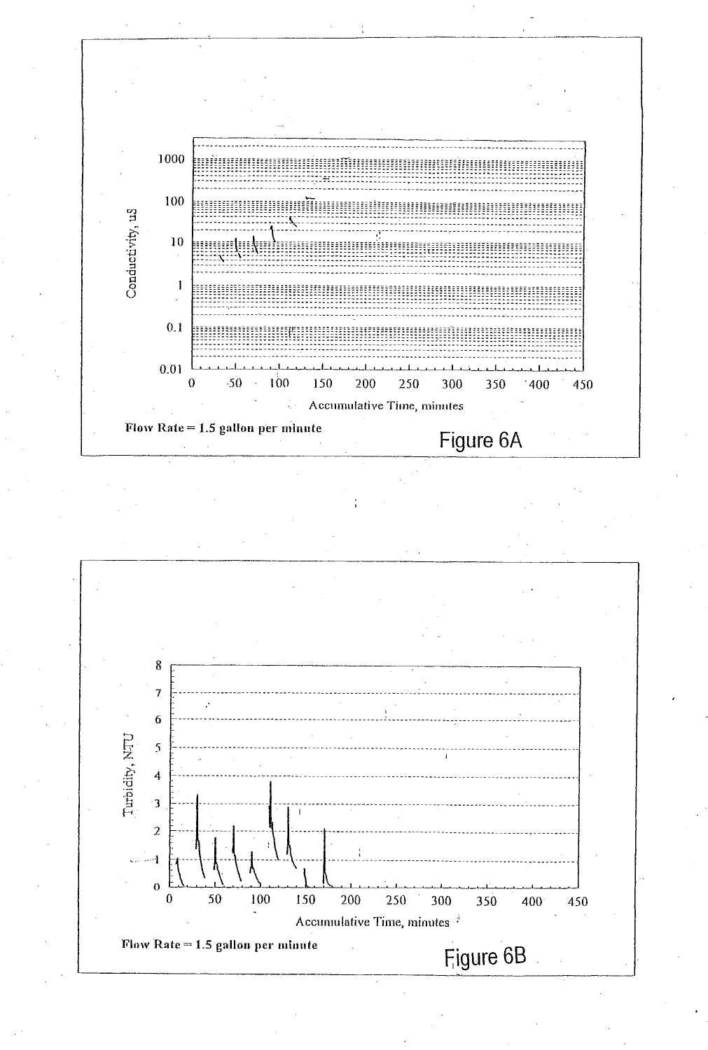

A reservoir containing water at room temperature was attached to the inlet of the POLYGARD® depth filter and the outlet of the IONEX® ion exchange resin cartridge to form a closed loop system. A pump was added between the reservoir and the POLYGARD® depth filter to move the water at a rate of 1.5 gallons per minute 102 grams of a liquid handsoap, Dial® Liquid Soap, was added to the water downstream of the pump but upstream of the POLYGARD® depth filter. Turbidity or cloudiness of the water along with conductivity as it exited the outlet from the IONEX® ion exchange resin cartridge were measured. Acceptable conductivity was deemed to less than 10 microSiemens. Acceptable turbidity was deemed to be less than 1 NTU. The system was tracked over time with 10 minutes being considered as the equivalent of one shower. The conductivity and turbidity never met the acceptance criteria. Based upon conductivity alone approximately five 10 minute showers could be made the prior art system. The conductivity and turbidity readings are shown in FIGS. 6A and 6B.

A filter of the present invention as shown in FIG. 1 was used. The filter contained a first depth filter made of MILLISTAK+ DE media, the second layer contained a second depth filter made of MILLISTAK+ DE media followed by a wound carbon fiber filter. The second stage contained a mixed bed of ion exchange media.

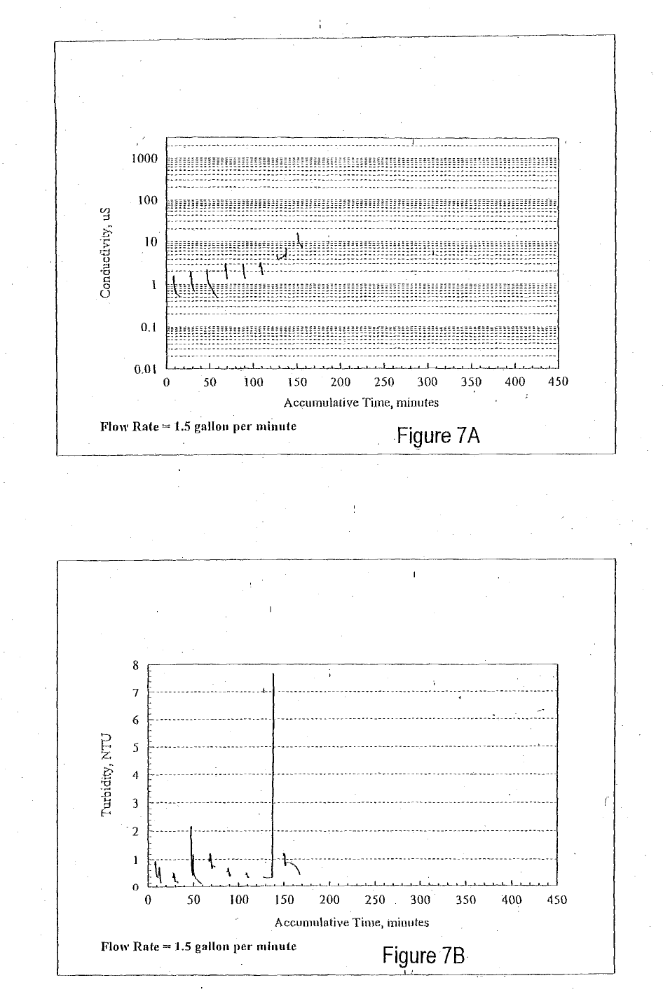

The cartridge was inserted into a system formed of a reservoir containing water at room temperature attached to the inlet of the filter of the present invention and the outlet of the filter of the present invention to form a closed loop system. A pump was added between the reservoir and the filter to move the water at a rate of 1.5 gallons per minute. 174 grams of a liquid handsoap, Dial® Liquid Soap, was added to the water downstream of the pump but upstream of the filter. Turbidity or cloudiness of the water along with conductivity as it exited the outlet from the filter were measured. Acceptable conductivity was deemed to less than 10 microSiemens. Acceptable turbidity was deemed to be less than 1 NTU. The system was tracked over time with 10 minutes being considered as the equivalent of one shower. The conductivity and turbidity were tracked over time and both were at acceptable levels until approximately 170 minutes or the equivalent of seventeen 10 minute showers. The conductivity and turbidity readings are shown in FIGS. 7A and 7B.

### EXAMPLE 2

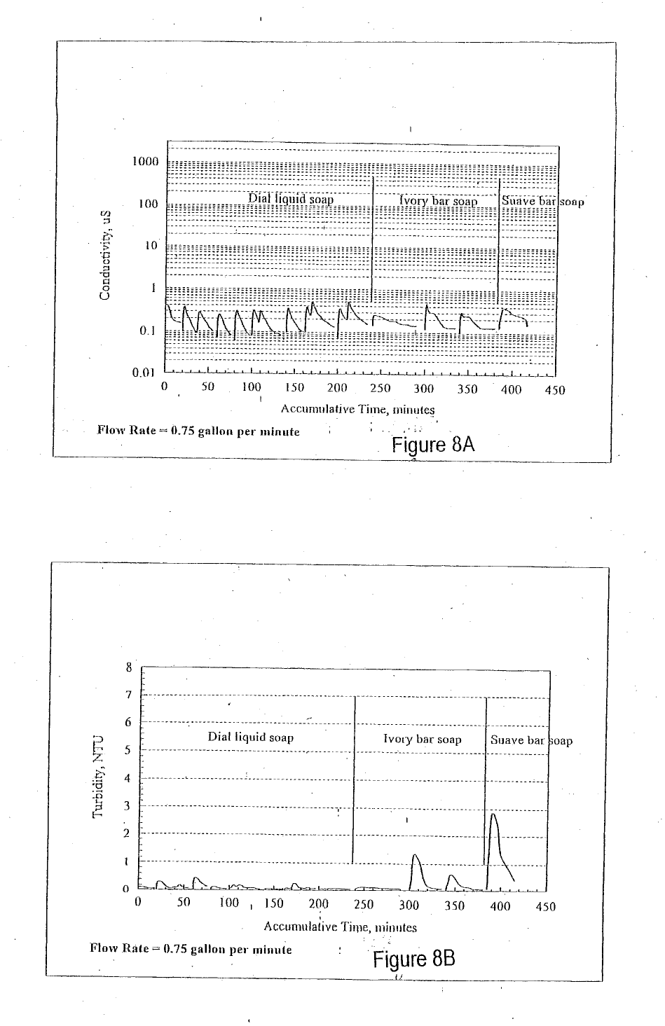

The system of the present invention as described above in Example 1 was run at rate of 0.75 gallons per minute with a variety of soaps; the liquid soap of Example 1 (85.4 grams) followed by 10 grams of shavings from a low additive containing bar soap (Ivory® soap) followed by 3.3 grams of a highly additive filled bar soap (Suave® soap) and conductivity and turbidity were measured at the outlet from the filter of the present invention. Acceptable conductivity was deemed to less than 10 microSiemens. Acceptable turbidity was deemed to be less than 1 NTU. The system was tracked over time with 10 minutes being considered as the equivalent of one shower. Conductivity remained below the cutoff throughout the test of 420 minutes. Turbidity was deemed to be unacceptable after 390 minutes or the equivalent of thirty nine 10 minute showers. The conductivity and turbidity readings are shown in FIGS. 8A and 8B.

### EXAMPLE 3

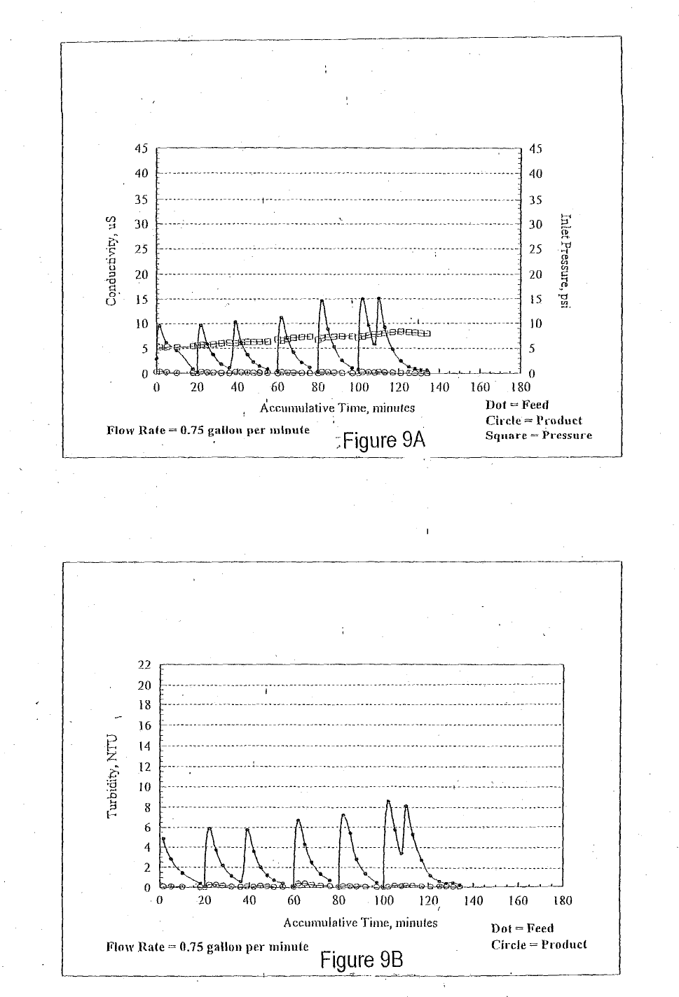

The system of the present invention as described above in Example 1 was run at rate of 0.75 gallons per minute with the liquid soap of Example 1 (43.8 grams) and conductivity, turbidity and pressure were measured at the inlet into the filter and the outlet from the filter of the present invention. Acceptable conductivity at the outlet was deemed to less than 10 microSiemens. Acceptable turbidity at the outlet was deemed to be less than 1 NTU. The system was tracked over time with 10 minutes being considered as the equivalent of one shower. Outlet conductivity and turbidity remained below the cutoff throughout the test of 135 minutes. The conductivity and turbidity readings are shown in FIGS. 9A and 9B.

The present invention provides a compact, economical and efficient filtration system for the reuse of gray water. It provides a large number of acceptable reuses of the gray water and does so in a small compact shape and design. Uses for such a cartridge and system are many. For example, such a cartridge and system can be used for portable showers or hand washing sinks such as on airplanes, boats, campers, recreational vehicles, space craft and the like where the amount of water that can be carried is limited. Likewise, it can be used on safaris and the like where the amount of water that can be carried is limited. Moreover, it may be used in homes or camp grounds where the supply of water is limited by natural conditions (arid lands) or drought. It may also be used for purposes other than washing such as watering vegetation (horticultural or agricultural) or washing automobiles, especially in locations with limited water supplies or outside watering restrictions or bans. Other uses will also become apparent to one of ordinary skill in the art from the teachings of the present invention and the appended claims are meant to encompass their uses as well.

What we claim:

1) A composite filter comprising a housing having a first end and a second end, each end being sealed in a liquid-tight manner by a first and a second endcap respectively, the first endcap having an inlet from a gray water source, the second endcap having an outlet from the housing, a first filter stage arranged in the housing adjacent and downstream of the inlet and a second stage arranged downstream of the first stage and adjacent the outlet, the first stage comprising a two or more depth filters in series followed by an organics filter, the first stage being arranged in a liquid-tight manner such that gray water entering the inlet must flow through the first stage before reaching the second stage and the second stage comprising an ion exchange media for the removal of dissolved ionic species from the gray water.

2) The filter of claim 1 further comprising a flow distributor between the first stage and the second stage.

3) The filter of claim 1 wherein the ion exchange media of the second stage is a bed of mixed ion exchange resins and further comprising a first flow distributor between the first stage and the second stage and a second flow distributor between the second stage and the outlet and wherein the first and second flow distributors contain the ion exchange media within the housing.

4) The filter of claim 1 wherein the Ion exchange media is selected from the group consisting of non-woven or woven grafted fabric and membranes, resin containing membranes and monoliths

5) The filter of claim 1 wherein the filters of the first stage are arranged concentrically around each other.

6) The filter of claim 1 wherein the filters of the first stage arranged concentrically around each other in the order of depth filter, depth filter, organics filter.

7) The filter of claim 1 wherein the filters of the first stage are arranged in series.

8) The filter of claim 1 wherein the depth filters of the first stage are formed of cellulosic and/or synthetic fibers.

9) The filter of claim 1 wherein the depth filters of the first stage are formed of cellulosic and/or synthetic fibers and one or more additives selected from the group consisting of diatomaceous earth, silica, carbon black, and mixtures thereof.

10) The filter of claim 1 wherein there are two depth filters in the first stage and at least the second depth filter is formed of cellulosic fibers and diatomaceous earth.

11) The filter of claim 1 wherein there are two depth filters in the first stage and the filters are formed of cellulosic fibers and diatomaceous earth.

12) The filter of claim 1 wherein at least one of the at least two depth filters in the first stage is formed of cellulosic fibers and diatomaceous earth.
